(19) United States
(12) Patent Application Publication
(10) Pub. No.: US 2013/0300049 A1
(43) Pub. Date: Nov. 14, 2013

(54) PORTABLE RACK FOR USE IN WORKING OF CONSTRUCTION TUBULAR

(71) Applicant: Juan M. Hernandez, San Antonio, TX (US)

(72) Inventor: Juan M. Hernandez, San Antonio, TX (US)

(21) Appl. No.: 13/555,132

(22) Filed: Jul. 21, 2012

Related U.S. Application Data
(60) Provisional application No. 61/688,312, filed on May 12, 2012.

(51) Int. Cl. B25B 11/00

(52) U.S. Cl. 269/296

(57) ABSTRACT

A portable rack for supporting a construction tubular during the working thereof includes a base having disposed at generally opposite ends thereof a pair of upwardly projecting tubular support pillars, each provided tubular support pillar having a generally V-shaped notch aligned one to the other. Each V-shaped notch is provided with disruptions adapted to promote frictional engagement in place of a supported construction tubular. Such disruptions may be formed as circular ribs, elliptical ribs, saw tooth shaped ribs, V-shaped notches, rectangle or square-shaped notches, or a patch of denticles or like protrusions or protuberances. The portable rack may be used on a workbench, tabletop, floor or on the ground.

### RELATED APPLICATION

This present application claims, under 35 U.S.C. §119(e), priority to and all available benefit of U.S. provisional patent application Ser. No. 61/688,312 filed May 12, 2012. By this reference, the entire disclosure, including the drawings, of U.S. provisional patent application Ser. No. 61/688,312 is incorporated herein as though now set forth in its entirety.

### FIELD OF THE INVENTION

The present invention relates to material handling. More particularly, the invention relates to a portable rack particularly adapted for supporting a construction tubular during the cutting or like working thereof.

### BACKGROUND OF THE INVENTION

Construction tubulars commonly require cutting to size at their specific location of use, which location will often time be a cramped or otherwise limited space such as for example an attic or crawlspace or the like. As a result, the available tools for facilitating such working of construction tubulars (such as, for example, vises and the like) are not sufficiently portable to be brought into the location of work, which in turn often results in the unsafe or ineffective handling of saws and the like. As a result, it is the overriding object of the present invention to improve over the prior art by introducing a portable rack for use in the working of construction tubular that is readily brought to and used at virtually any location of working. Additionally, it is an object of the present invention to provide such an article that is also readily and economically manufactured and simple to use, thereby ensuring that the article may be made available to the widest population.

### SUMMARY OF THE INVENTION

In accordance with the foregoing objects, the present invention—a portable rack for supporting a construction tubular during the working thereof—generally comprises a base having disposed at generally opposite ends thereof a pair of upwardly projecting tubular support pillars, each provided tubular support pillar having a generally V-shaped notch aligned one to the other.

In a critical aspect of the present invention, each V-shaped notch is provided with disruptions adapted to promote frictional engagement in place of a supported construction tubular. For example, the tubular engaging surfaces may be provided with generally transversely oriented circular ribs in order to increase to area of frictional contact between the tubular support pillars and the outer surface of the supported construction tubular. Alternatively, the tubular engaging surfaces may be provided with elliptical ribs, saw tooth shaped ribs, V-shaped notches, rectangle or square-shaped notches, a patch of denticles or like protrusions or protuberances, and any substantially equivalent structure.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a perspective view, the preferred embodiment of a portable rack as implemented in accordance with the teachings of the present invention;

FIG. 2 shows, in a top plan view, the portable rack of FIG. 1;

FIG. 3 shows, in a right end elevational view, the portable rack of FIG. 1;

FIG. 4 shows, in a front elevational view, the portable rack of FIG. 1;

FIG. 5 shows, in a bottom plan view, the portable rack of FIG. 1;

FIG. 6 shows, in the perspective view of FIG. 1; the portable rack of FIG. 1 as put to use in the support of a construction tubular;

FIG. 7 shows, in the right end elevational view of FIG. 3, the portable rack of FIG. 1 as put to use in the support of the construction tubular of FIG. 6;

FIG. 8 shows, in a front perspective view, the portable rack of FIG. 1 as put to use in the support of the construction tubular of FIG. 6 and, in particular, shows a first manner of use of the portable rack in connection with the cutting of a section from the construction tubular;

FIG. 9 shows, in the front perspective view of FIG. 8, the portable rack of FIG. 1 as put to use in the support of the construction tubular of FIG. 6 and, in particular, shows a second manner of use of the portable rack in connection with the cutting of a section from the construction tubular;

FIG. 10 shows, in a perspective view corresponding to that of FIG. 1, the preferred embodiment of a portable rack as implemented in accordance with the teachings of the present invention and, in particular, shows a first alternative implementation of the disruptions provided on the tubular engaging surfaces of the tubular support pillars of the portable rack;

FIG. 11 shows, in a perspective view corresponding to that of FIG. 1, the preferred embodiment of a portable rack as implemented in accordance with the teachings of the present invention and, in particular, shows a second alternative implementation of the disruptions provided on the tubular engaging surfaces of the tubular support pillars of the portable rack;

FIG. 12 shows, in a perspective view corresponding to that of FIG. 1, the preferred embodiment of a portable rack as implemented in accordance with the teachings of the present invention and, in particular, shows a third alternative implementation of the disruptions provided on the tubular engaging surfaces of the tubular support pillars of the portable rack; and

FIG. 13 shows, in a perspective view corresponding to that of FIG. 1, the preferred embodiment of a portable rack as implemented in accordance with the teachings of the present invention and, in particular, shows a fourth alternative implementation of the disruptions provided on the tubular engaging surfaces of the tubular support pillars of the portable rack.

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

Construction Tubular.

As used herein, the term “construction tubular” is expressly defined to include solid as well hollow members; to include members of any shape cross section (as opposed to in any manner being limited to members having circular or like cross sections); and to not be in any manner limited to members of any particular material of construction. In accordance with this definition, any by way of example only, exemplary construction tubulars in connection with which the present invention is particularly adapted for use include such members as polyvinyl chloride (“PVC”) pipe, such as commonly utilized in plumbing drain and vent applications; galvanized steel pipe or cross-linked polyethylene (“PEX”) tubing, such as commonly utilized in plumbing supply line applications; iron or “black” pipe, such as commonly utilized in natural gas supply applications; conduit, such as commonly utilized for the protection of electrical circuits; rebar, such as commonly utilized in concrete reinforcement applications; square or rectangular tubing or bar stock; or the like.

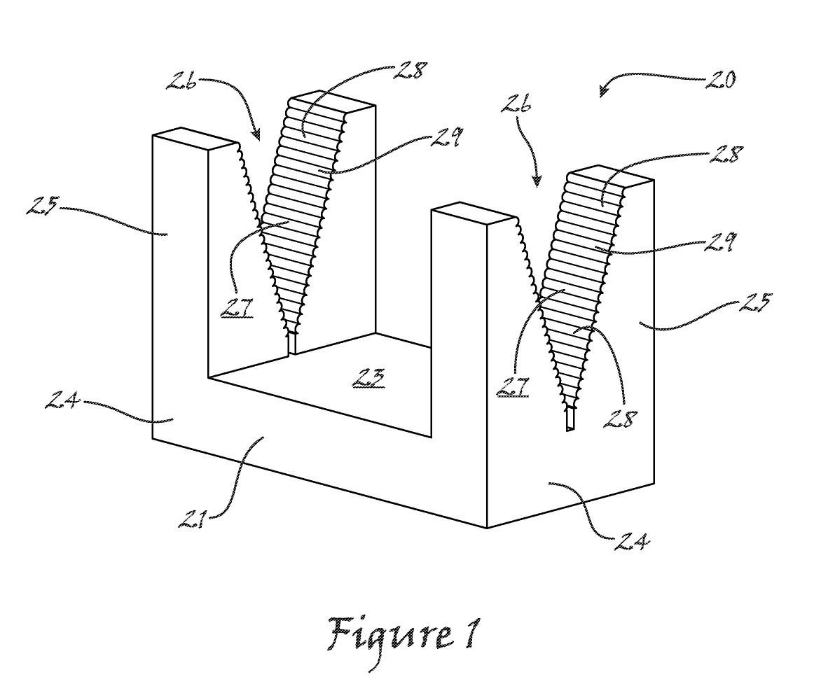

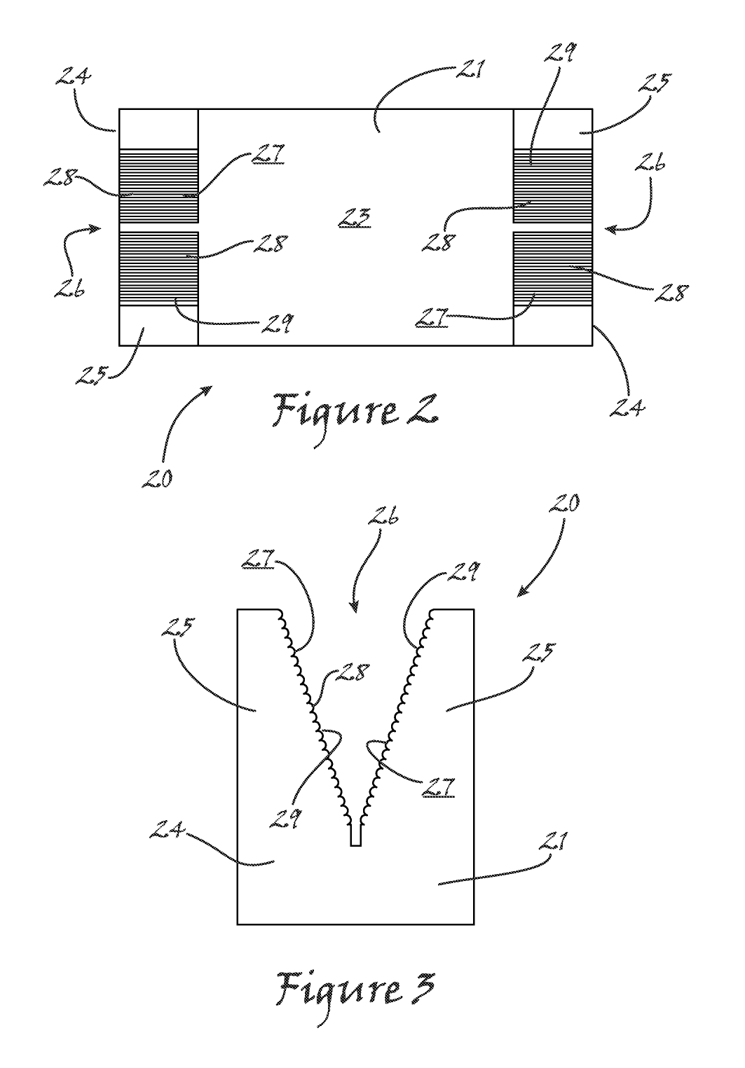

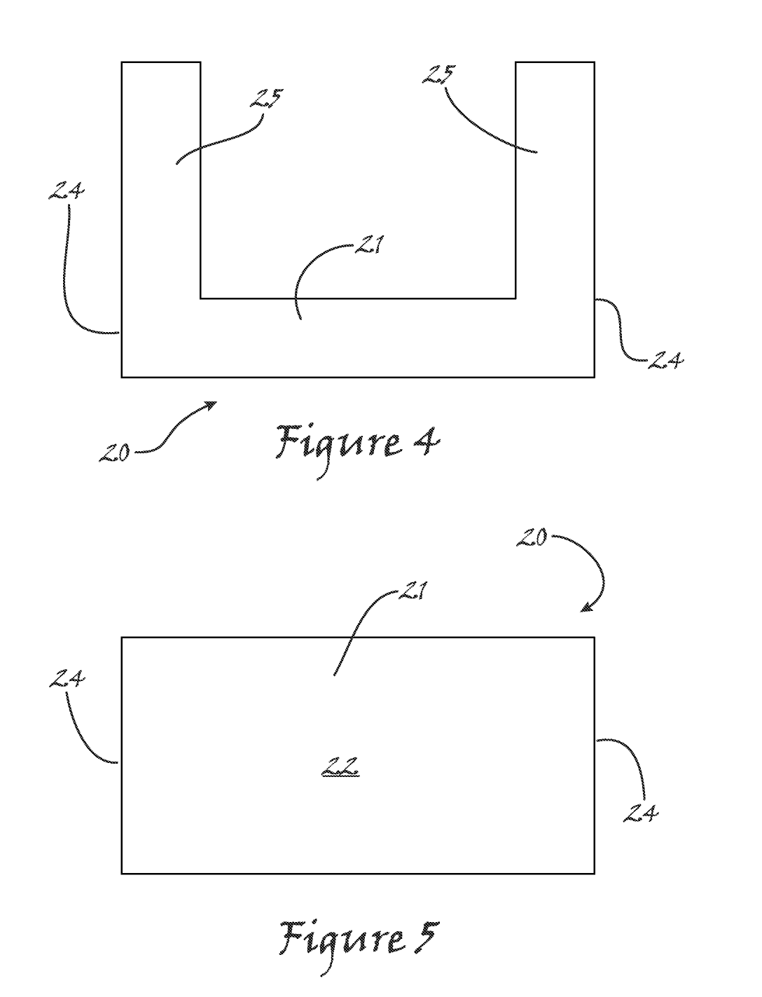

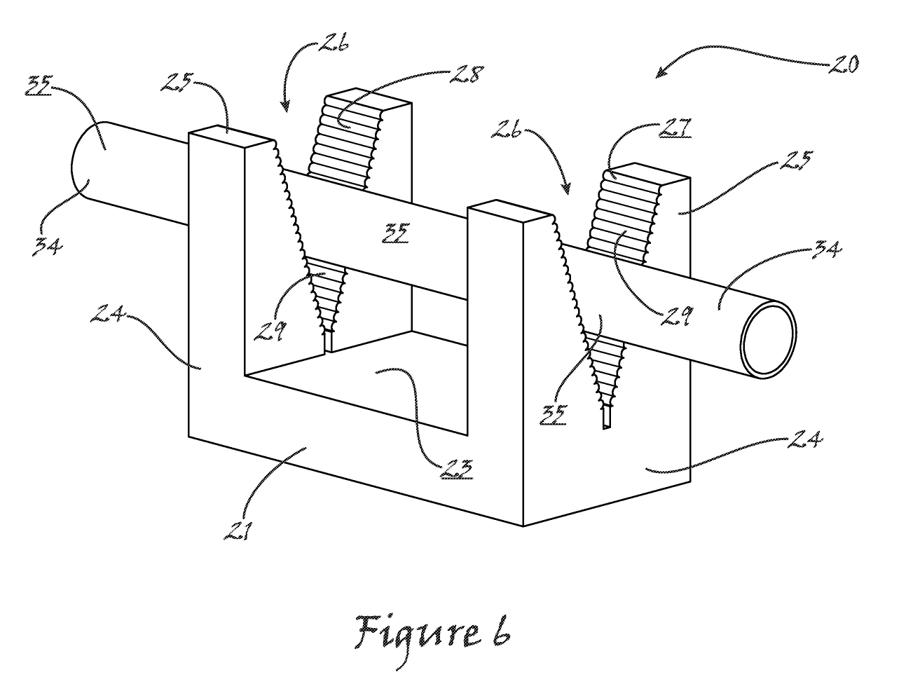

Referring now to the figures, and to FIGS. 1 through 5 in particular, the portable rack 20 of the present invention is shown to generally comprise a base 21 having disposed at generally opposite ends 24 thereof a pair of upwardly projecting tubular support pillars 25. As shown in the figures, each provided tubular support pillar 25 comprises a generally V-shaped notch 26 aligned one to the other as particularly depicted in FIGS. 1 through 3. As also shown in the figures, the base 21 of the rack 20 is provided with a generally planar bottom surface 22. Because, as will be better appreciated further herein, it is contemplated that the portable rack 20 of the present invention may be used on a workbench, tabletop, floor or on the ground, but also noting that it is intended that the portable rack 20 be easily ported from one location to another, Applicant has found that a suitable dimension for the bottom surface 22, balancing the requirements of portability with stability, is about six inches by about 12 inches. Those of ordinary skill in the art will recognized, however, that other sizes may be suitably implemented within the constraints of a particular application. Likewise, although the bottom surface 22 of the base 21 of the portable rack 20 is depicted as being generally rectangular in shape, those of ordinary skill in the art will recognize that virtually any shape may be implemented subject only to suitability for implementation of the other features of the invention as described herein.

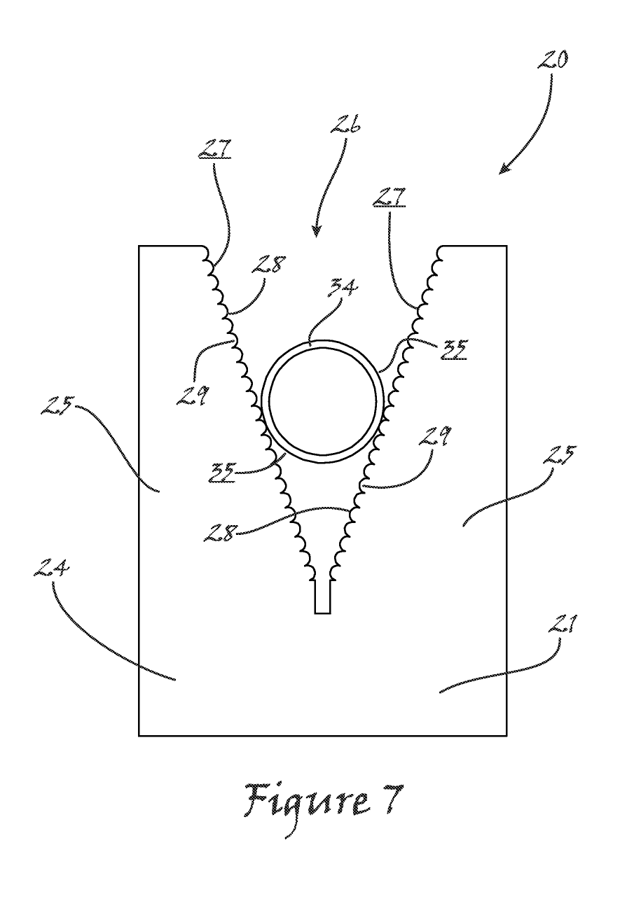

Turning then to FIGS. 6 and 7 in particular, it is shown that the portable rack 20 of the present invention is particularly adapted for supporting a construction tubular 34 (as defined herein) and, most particular, for supporting such a construction tubular 34 during the working thereof such as, for example, during the cutting of a section from the construction tubular 34. To this end, the oppositely disposed generally V-shaped notches 26 of the upwardly projecting pillars 25 are adapted as shown in the figures to cradle and support a construction tubular 34. In order to provide such support without inadvertent or unintended rotation or translation of a supported construction tubular 34, however, the tubular engaging surfaces 27 of each provided generally V-shaped notch 26 of each upwardly projecting pillar 25 is in a critical aspect of the present invention provided with disruptions 28 adapted to promote frictional engagement in place of a supported construction tubular 34. For example, as shown in FIGS. 1 through 3, 6 and 7, the tubular engaging surfaces 27 may be provided with generally transversely oriented circular ribs 29 in order to increase to area of frictional contact between the tubular support pillars 25 and the outer surface 35 of the supported construction tubular 34, as most particularly shown in FIG. 7.

Additionally, and in order to maintain the effectiveness of the provision in accordance with the present invention of the described disruptions 28 while nonetheless making the portable rack 20 of the present invention suitable for use with construction tubulars 24 having a diameter of up to about four inches, each of the provided generally V-shaped notches 26 of each pillar 25 is most preferably formed in the shape of an isosceles triangle having a base angle in the range of about 50 to about 55 degrees and each of the pillars 25 is formed to project about six inches upward from the top surface 23 of the base 21 of the portable rack 20.

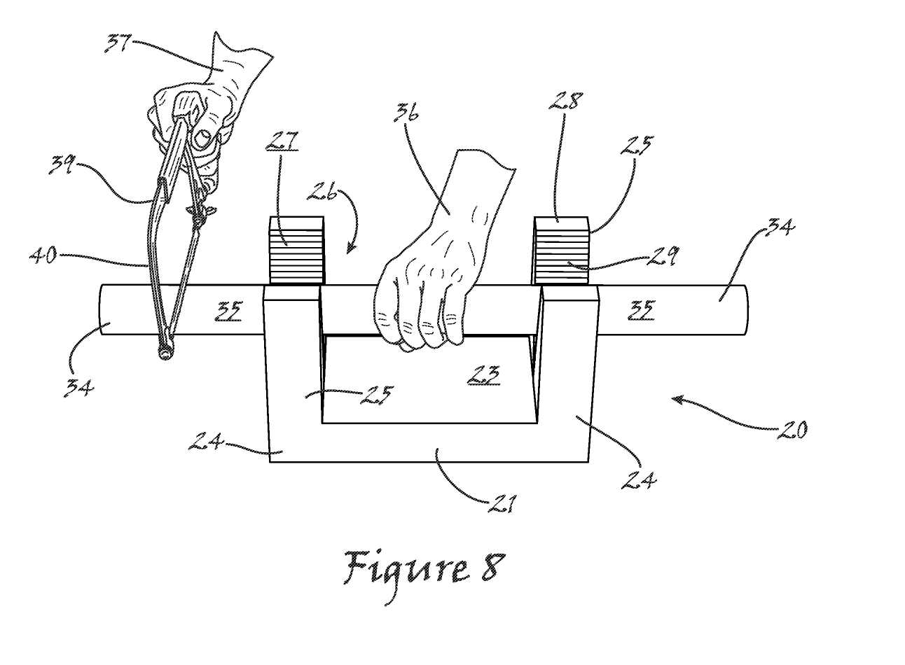

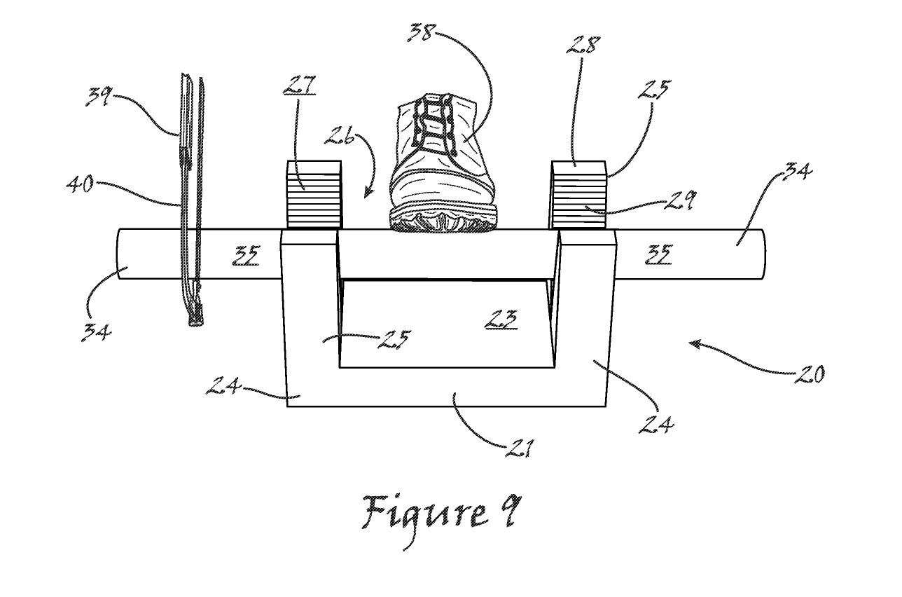

Referring now to FIGS. 8 and 9, the portable rack 20 of the present invention is depicted as put to use in the support of a construction tubular 34 while a user of the portable rack 34 cuts a section from the construction tubular 34. As shown in FIG. 8 in particular, the construction tubular 34 may be readily held with a first hand 36 while the user's second hand 37 operates a cutting tool 39, such as, for example, the depicted handsaw 40, to cut a section from the construction tubular 34. As will be appreciated by those of ordinary skill in the art, the depicted operation may take place on a workbench, a tabletop, a floor, the ground or the like as may be convenient and, in any case, the critical provision in accordance with the present invention of the described disruptions 28 will facilitate control by the user of the construction tubular 34 during working thereof. Likewise, as shown in FIG. 9 in particular, the construction tubular 34 may be readily held with a booted or like foot 38 while the user's hand 37 operates a cutting tool 39, such as, for example, the depicted handsaw 40, to cut a section from the construction tubular 34. In this case, however, it is noted that the critical provision in accordance with the present invention of the described disruptions 28 will so facilitate control by the user of the construction tubular 34 during working thereof that the user will have both hands 36, 37 free for the operation of a tool. In this manner, the portable rack 20 of the present is particularly adapted to facilitate use of cutting tools 39 such as power saws, bolt cutters and the like, which generally require the use of two hands for the safe and/or effective operation thereof.

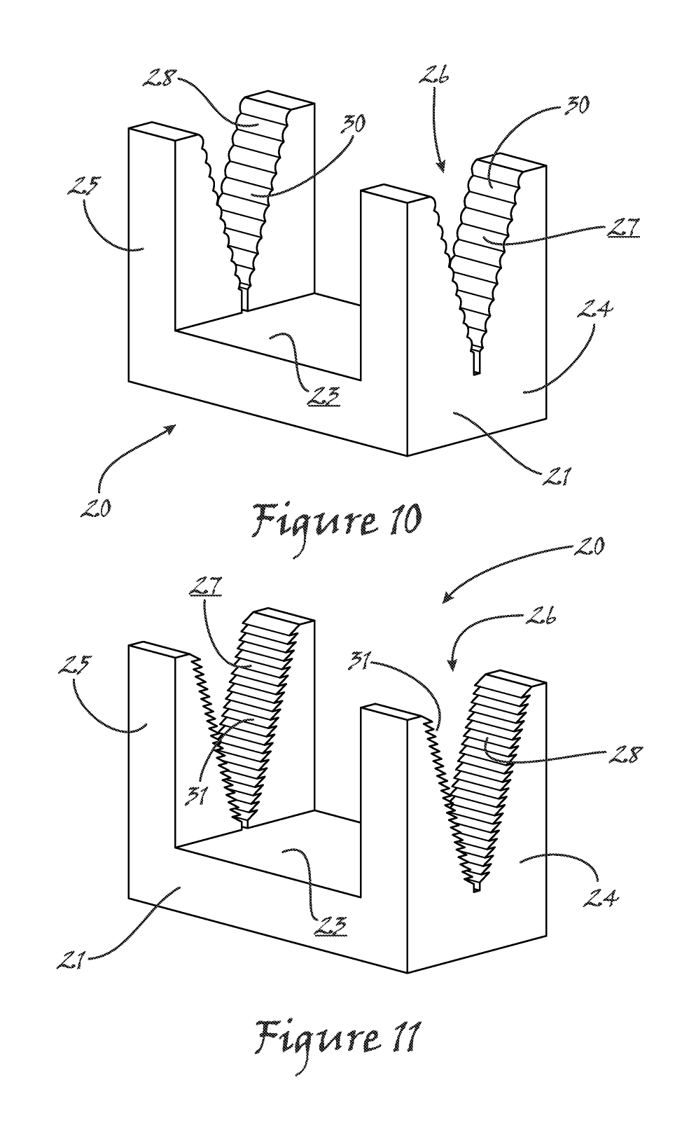

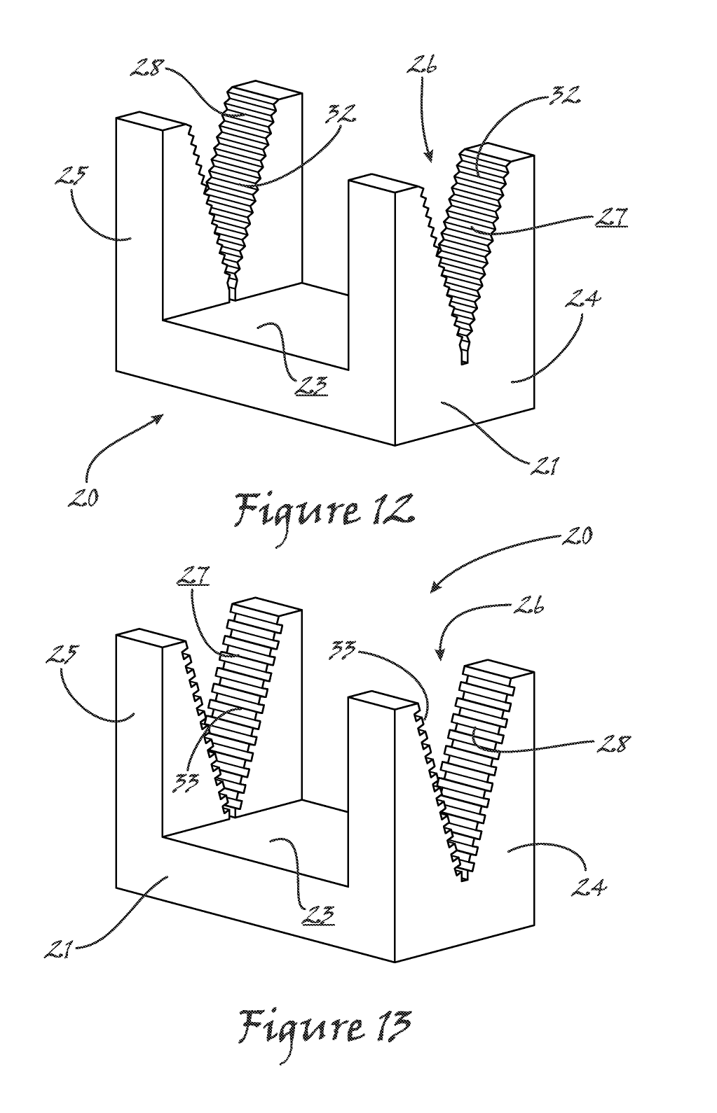

Finally, and with reference in particular to FIGS. 10 through 13, it is noted that the required disruptions 28 to the tubular engaging surfaces 27 may take a very wide variety of forms. For examples, such disruptions 28 may take the form of generally transversely oriented elliptical ribs 30, as particularly shown in FIG. 10; such disruptions 28 may take the form of saw tooth shaped ribs 31, as particularly shown in FIG. 11; such disruptions 28 may take the form of V-shaped notches 32, as particularly shown in FIG. 12; such disruptions 28 may take the form of rectangle or square-shaped notches 33, as particularly shown in FIG. 13; or such disruptions 28 may take other forms not shown such as, for example and without limitation, a patch of denticles or like protrusions.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, those of ordinary skill in the art will recognize that the portable rack 20 of the present invention may be constructed from any of a wide variety of materials such as, for example and without limitation, steel, aluminum, plastic, fiberglass, wood, rubber, highly resilient elastomers such as, for example, carboxylated nitrile rubber or other processed elastomeric material. Those of ordinary skill in the art will recognize, however, that the choice of material and corresponding appropriate method of manufacture may dictate or otherwise influence the choice for implementation of the required disruptions as a matter of manufacturability, such considerations being well within the ordinary skill in the art in light of this exemplary description.

Likewise, those of ordinary skill in the art will also recognize that depending on the choice of materials and the corresponding appropriate method of manufacture various portions of the described structure may, in order to make the portable rack 20 lightweight, be formed with hollow portions. In particular, portions of the base 21 as well as of the upwardly projecting pillars 25 may include such hollows. In any case, because the scope of the present invention is much broader than any particular embodiment, the foregoing detailed description should not be construed as a limitation of the scope of the present invention, which is limited only by the claims appended hereto.

What is claimed is:

1. A portable rack for supporting a construction tubular during the working thereof, said portable rack comprising:
a base;
a first pillar affixed to said base at a first end thereof, said first pillar having a first V-shaped notch formed therein and wherein the surfaces of said first V-shaped notch:
are adapted to frictionally engage a first portion of the outer surface of the construction tubular in support thereof; and
are provided with disruptions to promote said frictional engagement between said first V-shaped notch and the first portion of the outer surface of the construction tubular; and
a second pillar affixed to said base at a first end thereof generally opposite said first end, said second pillar having a second V-shaped notch formed therein and wherein the surfaces of said second V-shaped notch:
are adapted to frictionally engage a second portion of the outer surface of the construction tubular in support thereof; and
are provided with disruptions to promote said frictional engagement between said second V-shaped notch and the first portion of the outer surface of the construction tubular.

2. The portable rack for supporting a construction tubular as recited in claim 1, wherein said disruptions comprise circular ribs.

3. The portable rack for supporting a construction tubular as recited in claim 1, wherein said disruptions comprise elliptical ribs.

4. The portable rack for supporting a construction tubular as recited in claim 1, wherein said disruptions comprise saw tooth shaped ribs.

5. The portable rack for supporting a construction tubular as recited in claim 1, wherein said disruptions comprise V-shaped notches.

6. The portable rack for supporting a construction tubular as recited in claim 1, wherein said disruptions comprise rectangular-shaped notches.

7. The portable rack for supporting a construction tubular as recited in claim 6, wherein said disruptions comprise square-shaped ribs.

8. The portable rack for supporting a construction tubular as recited in claim 1, wherein said disruptions comprise protrusions.

9. The portable rack for supporting a construction tubular as recited in claim 8, wherein said disruptions comprise denticles.
